(19) United States
(12) Patent Application Publication
(10) Pub. No.: US 2013/0241694 A1
(43) Pub. Date: Sep. 19, 2013

(54) NON-CONTACT ELECTRONIC DOOR LOCKS HAVING SPECIALIZED RADIO FREQUENCY BEAM FORMATION

(71) Applicant: SECUREALL CORPORATION, MOUNTAIN VIEW, CA (US)

(72) Inventors: Arun Kumar Sharma, Cupertino, CA (US); Michael Wurm, Redwood City, CA (US); Richard Schaffzin, Mountain View, CA (US); David Arthur Candee, Milpitas, CA (US)

(21) Appl. No.: 13/843,757

(22) Filed: Mar. 15, 2013

Related U.S. Application Data
(60) Provisional application No. 61/611,577, filed on Mar. 16, 2012.

(51) Int. Cl. G08C 17/02

(52) U.S. Cl. CPC G08C 17/02
USPC 340/5.64

(57) ABSTRACT

An electronic door lock (“EDL”) is adapted to interact with an electronic key unit having a key antenna and a transmitter configured to transmit a radio frequency (“RF”) signal over the key antenna, the RF signal containing an identification (“ID”) code identifying the electronic key unit. The EDL can include a first antenna adapted to form a first directional radiation beam to receive the RF signal from the key unit, a second antenna adapted to form a second directional radiation beam to receive the RF signal from the key unit, and a processing component adapted to use RF signals received by one or both of the first and second antenna to determine whether the presence of an acceptable ID code is detected on the key. The EDL can determine the location of the key, and whether the key is inside or outside of the room.

### CROSS-REFERENCE TO RELATED APPLICATION

This application claims priority to U.S. Provisional Application No. 61/611,577 filed on Mar. 16, 2012, entitled “DOOR LOCK OR LOCATOR APPLIANCE WITH RF BEAM FORMATION FOR COMMUNICATION WITH PARTNER APPLIANCE,” which is incorporated by reference herein in its entirety and for all purposes.

### TECHNICAL FIELD

The present invention relates generally to door locks, and more particularly to electronic door locks and systems that operate using electronic keys, key fobs or the like.

### BACKGROUND

An electronic key (“E-Key” or “EKey”) can be used in many situations to unlock doors or otherwise provide access to a secure area. Many modern hotels and business places, residences and the like utilize such EKeys, often in the form of readable cards. Such EKeys can be in the form of card keys, key-fobs, tokens and the like. Examples of EKey technologies can include magnetic stripe cards, smart cards, near field radio frequency communications (“NFC”), passive radio frequency identification (“RFID”), active RFID, and so forth. Whichever technology is used, the EKey typically communicates with an electronic door lock (“EDL”) or other suitable electronic lock or access component. The EDL or other electronic access device can then read a particular identification (“ID”) code on the EKey and provide or deny access based upon whether the ID code is acceptable to the EDL.

Many types of EKey and EDL technologies require that the card or key fob being used be physically placed into contact with the EDL, such as in the case of magnetic stripe cards, smart cards, memory chip cards and fobs. Of course, such applications tend to require the user to handle the EKey, such as to insert a card into a slot in the EDL. Other types of technologies can allow for applications where no physical contact is required between the EKey and EDL, such as in the case of NFC cards and readers. Unfortunately, NFC applications typically need the EKey to be within a few centimeters of the EDL or other reader, such that users are usually required to handle the EKey to some degree.

While a true “hands-free” EKey and EDL system could be an attractive concept with great market potential, there are some practical obstacles in realizing such a system. Again, while reliable, an NFC system requires the card or fob to be very close to the reader. Conversely, typical “far field” radio frequency (“RF”) applications can be somewhat problematic. For example, if an ordinary RF EKey and EDL system is designed to use far field RF communication to provide secure access for an office, hotel, or other building room, the EDL will typically read the EKey regardless of whether the user is outside or inside the room. Of course, an EKey and EDL system where the EKey is continually unlocking the door while the EKey is inside the room is simply not practical, nor will it be acceptable to the user. While there may have been some attempts to solve this problem with RF technologies in EKey and EDL applications, the reliability of such applications must be extremely high in order for users to accept them, and will invariably require other sensors and involve operating mode logic to achieve the desired locking and unlocking behaviors.

In addition to the foregoing issues, it would also be desirable for a true long range “hands-free” EKey and EDL solution to be able to detect the exact location of a given EKey with respect to the EDL in terms of spatial orientation and distance. Such abilities can be beneficial, such as where a longer range might be desirable for a handicapped or other impaired user. As such, the ability to adjust the range for a given user would also be useful.

While many devices, systems and methods used to provide EKeys and EDLs have generally worked well in the past, there is always a desire for improvement. In particular, what is desired are improved EKeys and EDLs that reliably allow users the ability to have possession of EKeys in order to access rooms and other secure areas without having to physically handle or manipulate the EKeys.

### SUMMARY

It is an advantage of the present invention to provide EDLs that reliably allow users the ability only to require possession of EKeys in order to access rooms and other secure areas without having to physically manipulate the EKeys. This can be accomplished at least in part through the use of far field RF based systems that use antennas having directed beams in a manner so as to determine the distance and direction of the EKey with respect to the EDL.

In various embodiments of the present invention, an electronic door lock (“EDL”) is adapted to interact with an electronic key unit having a key antenna and a transceiver configured to communicate via a radio frequency (“RF”) channel over the key antenna, where the RF communication contains an identification (“ID”) code and encryption protocol identifying the electronic key unit and/or EDL. The EDL can include a first antenna adapted to form a first directional radiation beam to communicate with the key unit, a second antenna adapted to form a second directional radiation beam to receive the RF signal from the key unit, and a processing component adapted to use RF signals from one or both of the first and second antenna to determine the presence of an EKey that has access permission to the EDL.

In various detailed embodiments, the processing component can be adapted to determine the distance and spatial location of the key unit with respect to the electronic door lock to within an accuracy of about 15 or 20%. In some cases, the EDL can have its first directional radiation beam point to the inside of the door and the second directional radiation beam point to the outside of the door. A third antenna adapted to form a third directional radiation beam to receive the RF signal from the key unit can also be added. In such embodiments, the third antenna can point in the same general direction inside or outside as one of the other two antennas. Fourth or even more antennas can also be added as desired.

In further detailed embodiments, the EDL can include a metal escutcheon housing at least one or more of the antennas. In some embodiments, the metal escutcheon is itself an integral radiative element of the antenna. In addition, the metal escutcheon can have a thin slot cut to serve as a slot antenna. Such an escutcheon slot antenna can be configured to radiate only at one side by providing a cavity backing, such as a cavity backed slot antenna. In some embodiments, the metal escutcheon housing can have two crossing slots formed therein to provide a composite antenna that provides both vertical and horizontal polarization slot antennas. The escutcheon cross slot antenna can be configured to radiate only at one side by providing a cavity backing. In addition, an exterior radome can be configured to mechanically cover and protect the two crossing slots. Further, at least one of the first and second antennas can operate such that for an escutcheon having a frontal area A, a width W, and a height H, its operating frequency F is the greater of the following possible equation results

F=0.5×300,000,000/sqrt(A)

F=0.5×300,000,000/W

or

F=0.5×300,000,000/H

These results correspond to the physical dimension of the escutcheon being half of the free space wavelength or larger (in MKS system of units).

Also, the escutcheon can include an aperture that is used for an antenna to perform RF communication with EKeys. The portion of aperture used as an antenna element can also be used for an indicator light, a non-contact backup power transfer, or a capacitive touch sensor for user input or interaction. In some embodiments, at least a portion of the metal escutcheon surface is used as part of one of said antennas. The antennas can be selected from the group consisting of a patch antenna, a slot antenna, a cavity backed slot antenna, a dipole antenna, a folded dipole antenna, an inverted F antenna, and an L antenna. Further, the operating frequency of one or more antennas is at least 2 GHz in some instances. In some cases, each antenna consists of two radiating elements in close proximity that radiates in two different linear polarizations with respect to each other, either at the same time or at different temporal times. In some cases, the first antenna is located on an escutcheon inside of the room and provides coverage through an associated RF transparent door to the door exterior. Still further, the multiple directional radiation beams make it possible to discern whether an associated EKey is entering or leaving a room associated with the electronic door lock while an associated door is in an open or ajar state.

In various additional embodiments, an electronic door lock system can include a plurality of electronic door locks adapted to interact with an electronic key unit having a key antenna and a transmitter configured to transmit a radio frequency (“RF”) signal over the key antenna, the RF signal containing an identification (“ID”) code identifying the electronic key unit, wherein each of the plurality of electronic door locks includes a first antenna adapted to form a first directional radiation beam to receive the RF signal from the key unit, a second antenna adapted to form a second directional radiation beam to receive the RF signal from the key unit, a processing component adapted to use RF signals received by one or both of the first and second antenna to determine whether the presence of a correct ID code is detected on the key, as well as a server in communication with the plurality of electronic door locks, said server being adapted to update information on each of the plurality of electronic door locks regarding allowable ID codes for new or reissued electronic key units.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive apparatuses and methods for contact free electronic door locks that utilize specialized radio frequency beam formation. These drawings in no way limit any changes in form and detail that may be made to the invention by one skilled in the art without departing from the spirit and scope of the invention.

FIG. 1A illustrates in front perspective view an exemplary magnetic card swipe based EDL.

FIG. 1B illustrates in front perspective view an exemplary NFC based EDL and associated NFC EKey.

FIG. 2 illustrates in side elevation view an exemplary single far field RF based EDL according to one embodiment of the present invention.

FIG. 3 illustrates in block diagram format an exemplary far field RF based EDL system adapted for use with multiple EDLs according to one embodiment of the present invention.

FIGS. 4A through 4E illustrate a typical radiation pattern along three axes for a given RF antenna arrangement in a far field RF based EDL according to one embodiment of the present invention.

FIG. 5A illustrates in side elevation view an exemplary single far field RF based EDL having three directed beam antennas according to one embodiment of the present invention.

FIG. 5B illustrates a set of antenna radiation patterns representing antennas having good front to back ratios compared to antennas with moderate ratios for the three antenna EDL of FIG. 5A according to one embodiment of the present invention.

FIG. 5C depicts in two different partially disassembled views the RF based EDL having three directed beam antennas from FIG. 5A according to one embodiment of the present invention.

FIG. 6 illustrates in block diagram format various components of an overall circuit for the exemplary RF based EDL of FIG. 5A according to one embodiment of the present invention.

FIG. 7 illustrates in side elevation view an exemplary alternative single far field RF based EDL having four directed beam antennas according to one embodiment of the present invention.

FIG. 8 illustrates in block diagram format various components of an overall circuit for the exemplary RF based EDL of FIG. 7 according to one embodiment of the present invention.

FIGS. 9A through 9H illustrate in various views exemplary escutcheons, escutcheon slots, cross slot arrangements, cavity backed slot antennas and slot covering radomes according to various embodiments of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The present invention relates in various embodiments to EKey and EDL systems that reliably allow users the ability to have possession of EKeys in order to access rooms and other secure areas without having to physically handle the EKeys. Such “hands-free” usage of EKeys can preferably be accomplished reliably at distances of many feet from the EDL, and can also take place regardless of the orientation and location of the EKey on the person of the user. In addition, the various system embodiments herein can permit a given operator to adjust the activation range of a given EKey and EDL combination, so as to increase or decrease the activation range of a given EKey to account for user handicaps or stricter security.

Although the various embodiments set forth herein are described with respect to a building door, such as office doors on a corporate campus, resident doors in a senior care facility, or doors to hotel rooms, it will be understood that the present invention can be used in a wide variety of applications. For example, the various EKey and EDL embodiments provided herein can be used to unlock outside gates or secured regions, parking garages, vehicle door access, safe or lockbox access, and safety deposit box access, among other possible applications.

### Electronic Locks

While a wide variety of applications are possible, examples are provided herein with respect to building door EDLs due to the relatively small size and tight security requirements on such applications. However, comparisons to other types of applications may provide some perspective. For example, electronic locks used in cars can be simpler to realize. This is because a car battery recharges every time the car is driven, such that there are much higher peak power and average power loads, and also because the car body is voluminous such that the electronics, antenna, and so forth can take advantage of the relatively large metallic surface area and volume under the skin of the car. Further, there is no strict requirement that a car door should not unlock just because an EKey is located inside the car, since the presence of a driver in the car can be detected by other sensors, and because the vehicle door lock position can be set through other switches in the car.

Conversely, EDLs used in room doors and in buildings tend to be highly constrained. For example, the actual physical size of the door lock tends to be only about 3-4 inches wide and about 8-12 inches tall. Due to cost concerns, it is desirable for many building EDLs to be battery operated. As such, energy budget and peak power considerations tend to be serious design constraints on building EDLs. For these and other reasons, technologies used in EDLs for building and room doors can be easily applied in EDLs for cars, but the reverse generally is not true.

Again, non-contact EDL systems generally use NFC technologies, which then to require the EKey to be in very close proximity to the EDL. Some proximity card EDLs can use relatively low frequencies of about 125 KHz (i.e., a free space wavelength of about 2400 m) or even 13.56 MHz (i.e., a free space wavelength of about 22 m). The wavelength at these frequencies is so huge compared to the physical size of an EDL, however, that it is very difficult or impossible to realize an antenna that can radiate a far field RF radiation with a useful radiation efficiency of even a few percent. As such, many non-contact EDL systems simply operate as NFC with a very short communication range on the order of a few centimeters. In such systems, the transmitter and receiver antennas are essentially operating as loosely coupled transformers, the antenna is realized by having a large diameter coil that is tuned with a capacitor to resonate at the intended operating frequency, and the EDL antenna is exposed to exterior space housed in a large plastic insulator covered space in the escutcheon or housing. Further, considerable effort is made to minimize the use of non-electronic (i.e, structural) metal near the antenna coil.

The design and use of strong escutcheons is also important for security reasons. In general, an EDL escutcheon or housing having an all metal construction is recognized by many operators and users to be a sign of a robust and tough lock. Conversely, an escutcheon design that has a large pocket devoid of metal and filled by plastic is seen as one that can be relatively easily broken by a thief or vandal. In the event of a relatively weak escutcheon, a thief or vandal could at least damage and make inoperative the EDL while not necessarily defeating the lock. Worse, the thief or vandal could penetrate the escutcheon skin to gain access to the internal lock structure and defeat the lock to gain access to the room or other secure area.

While operators and users might prefer a true “hands-free” EKey and EDL system, such systems must be reliable. For example, an office, campus, resident, or hotel room door unlocking when a user with an EKey is inside the room but close to the door is unacceptable. If an EDL uses an NFC radio that can hypothetically transmit 100,000 times more power than a general NFC based product, this would increase the operating range of the NFC unit by only about 50-fold. Still, the radiation pattern of an NFC unit is almost impossible to control in a way that radiates only outside of a door and not toward the interior as well. Thus, such a powerful NFC unit would still unlock the door even when an authorized EKey is inside the room and close to the door. This is an unacceptable result. A reasonably long operating distance for an EKey from and EDL can be attractive, but this tends to be where the operating distance is applicable for well-defined angles or regions. For example, the system should recognize a closed door situation with one or more antenna pointing outside of the room where the user with the EKey is expected to be present as he or she walks up to the door and EDL. The EDL should unlock in this situation. Conversely, the EDL should not unlock when a user with the EKey is already inside the room but situated close to the inside portion of EDL.

The present invention overcomes the foregoing constraints and problems by employing a plurality of electromagnetic antennas that utilize far field radiation and use directional beams pointing in a well-defined spatial orientation. While far field systems can provide greater operating range, various disclosed embodiments also importantly solve the problem of using an operating frequency that lends itself to suitable beam formation for a given restricted size of an EDL, such as on an office, resident, or hotel room door, or other building door.

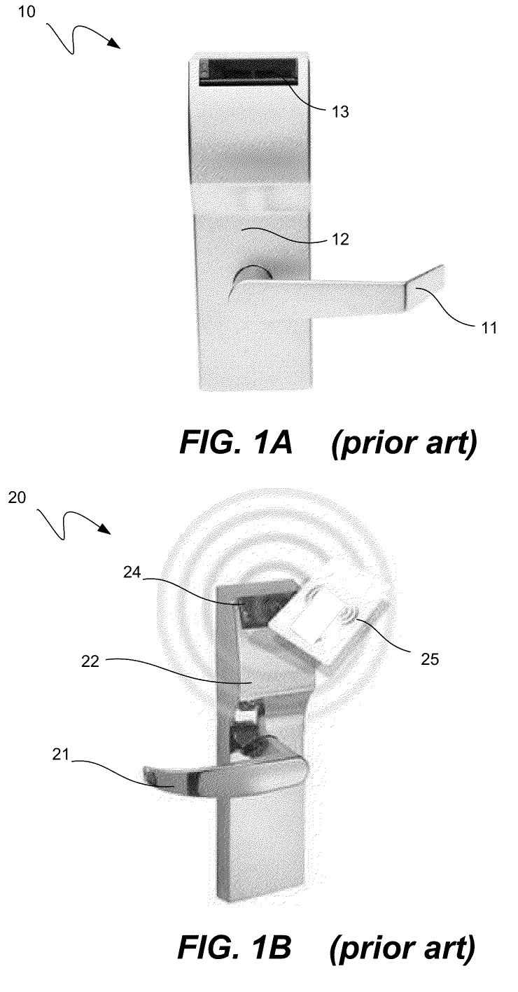

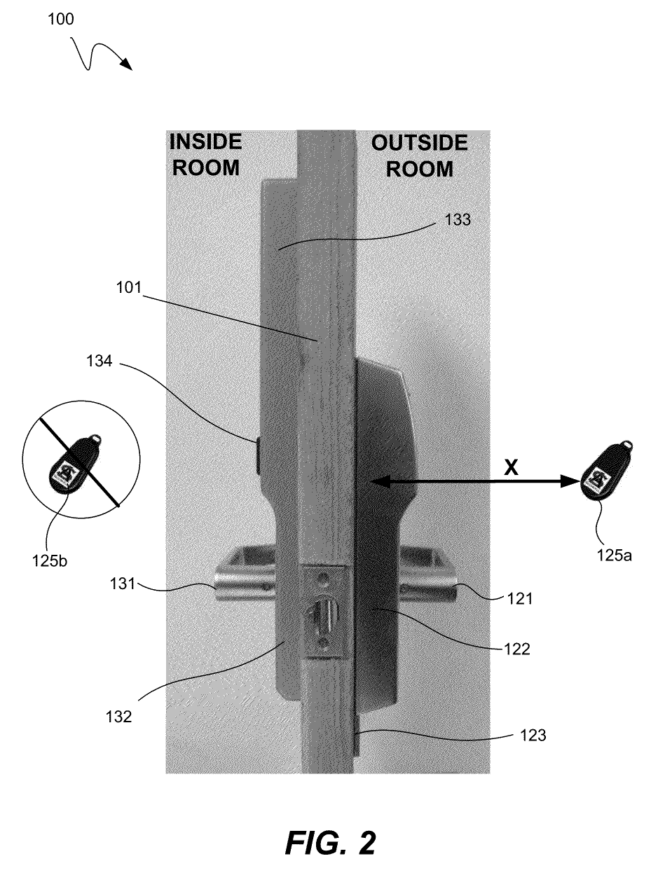

Referring first to FIG. 1A, one example of a magnetic card swipe based EDL is shown in front perspective view. The use of magnetic stripe cards as EKeys is generally well known, and magnetic stripe EDL 10 is adapted for use with such mag stripe card EKeys. Magnetic stripe EDL 10 can include, for example, a door handle 11 that is unlocked when a proper EKey is used, a metallic outer housing or escutcheon 12 and a large metal body and cutout slot 13 adapted to accept a mag stripe card EKey. Continuing with FIG. 1B, an exemplary NFC based EDL and associated NFC EKey are also shown in front perspective view. The use of NFC cards as EKeys is also generally well known. NFC based EDL 20 can similarly include a door handle 21 that becomes unlocked when a proper EKey is used, a metallic outer escutcheon 22 and a large cavity housing an NFC coil antenna and covered with a plastic radome 24. An NFC card 25 is also shown as being at a distance close enough to operate the NFC EDL. Again, EKey 25 must be very close to the EDL 20 in order for the NFC technology to work. In general, escutcheon 22 is made of metal, with space created for the NFC antenna by cutting out a large aperture in the metallic escutcheon. This is done to house the antenna as far away from the escutcheon metal as possible, such that the antenna can operate properly without too much detuning due to escutcheon metal. The surface of escutcheon 22 is then covered with a plastic or other non-conducting material near the antenna to allow the antenna to access the outside space. While full metal escutcheon EDLs, with possibly small apertures, give users and operators a feeling of security, large apertures filled with plastic give the appearance of a less robust and less safe product.

### Far Field RF Electronic Door Locks

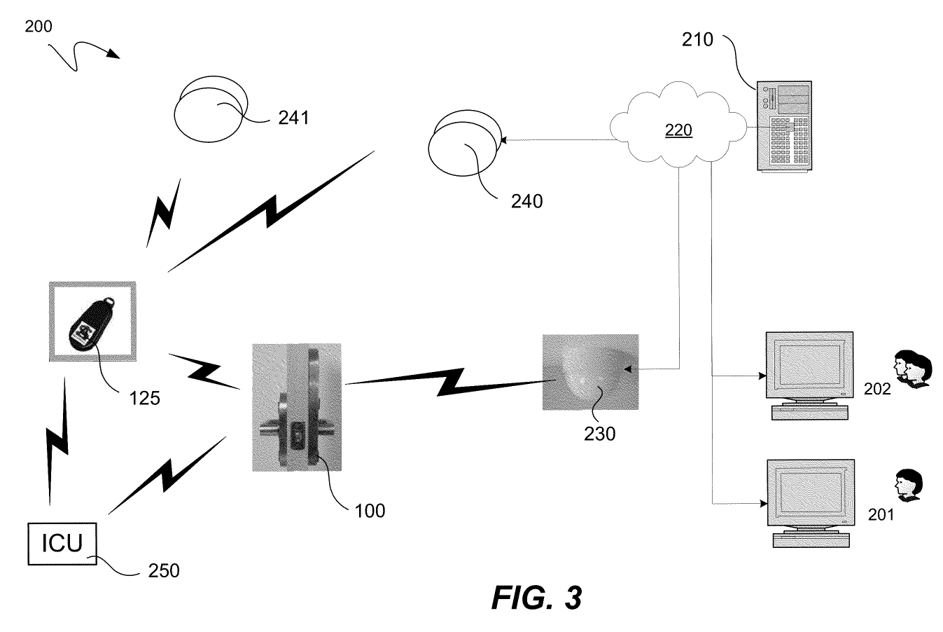

Turning next to FIG. 2, an exemplary single far field RF based EDL according to one embodiment of the present invention is shown in side elevation view. Far field RF based EDL 100 can include portions that are inside and outside door 101. The outside portion can include door handle 121 that is unlocked when an EKey with access permission is present, an outside escutcheon 122, and one or more RF antenna 123 embedded within the outside escutcheon. The inside portion can similarly include a handle 131, an inside escutcheon 132 and one or more RF antenna 133, 134 embedded within the inside escutcheon. Unlike the NFC EKey, the disclosed RF EKey 125a can be operable to unlock EDL 100 at a significant distance “X” from the EDL. In some embodiments, a given EKey 125a can unlock EDL 100 from outside the room at a distance of many feet from the EDL, such as by determining a “received signal strength indicator” (“RSSI”) from the EKey. For example, in some embodiments, the distance can be up to six feet or more. Other distances are also possible. Furthermore, an omni-directional EKey 125a can be operable to unlock EDL 100 regardless of its orientation or whether it is concealed in a pocket or purse, or alternatively held in the open by a user. Various details regarding an EKey with an omni-directional antenna can be found at, for example, U.S. Patent Publication No. 2012/0169543 A1, which is incorporated by reference herein for that purpose.

Conversely, another suitable RF EKey 125b that is inside the room will not unlock EDL 100 from inside the room. It will be readily appreciated that EKey 125b could also be EKey 125a simply being moved inside of the room. Such a function does not mean that EDL 100 does not detect EKey 125a or 125b when these keys are inside the room. Rather, the EDL operates such that it can detect the presence of these EKeys but “knows” that they are inside the room, such that the EDL does not unlock the door in such instances. The ability to detect whether the EKey 125a is inside or outside of the room, and in some instances detect the actual distance of the EKey from the EDL, is a result of the design and interaction of multiple RF antennas inside EDL 100, as set forth in greater detail below. In general, the RF based EDL 100 and Ekey 125 combination provides much greater range than a typical NFC contact free EDL without sacrificing reliability, integrity or safety. Again, users and operators prefer an EDL with a safe appearance, such as one having all metal or mostly metal outer escutcheon with minimal openings.

As will be readily appreciated, each EKey can have its own key antenna and a transmitter configured to transmit an RF signal over the key antenna, with the RF signal containing an identification (“ID”) code identifying the electronic key unit. Each EKey can have a permanent ID code associated therewith in some embodiments. Alternatively, each EKey can be reprogrammable to be assigned a new ID code as may be convenient for a given operator. The ID codes are then read by the EDL to determine whether a match is present such that the door can be unlocked.

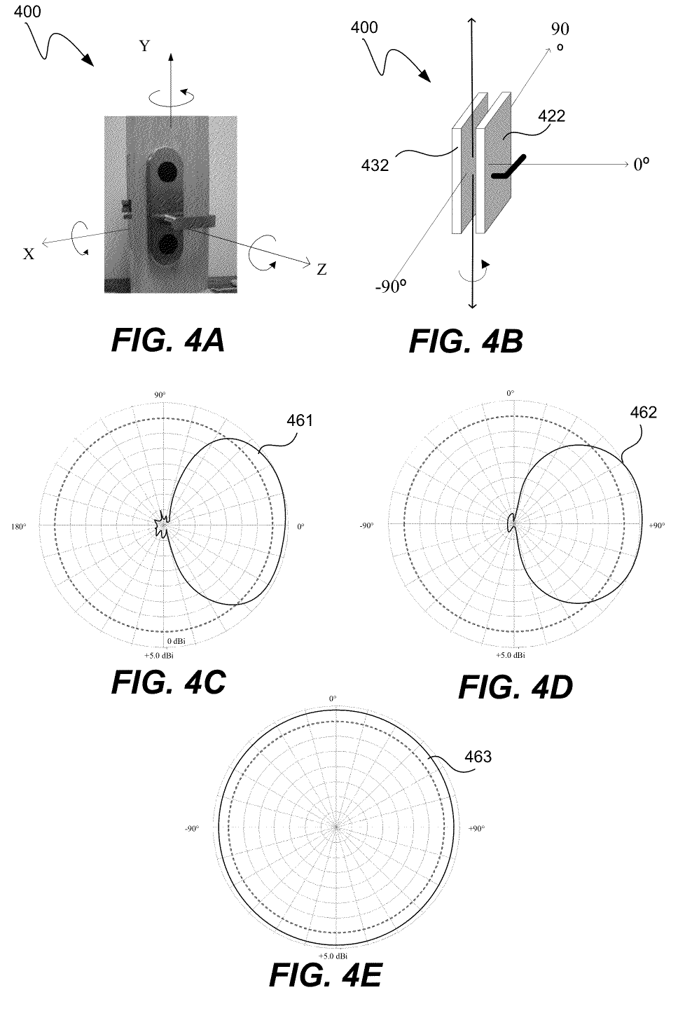

Moving next to FIG. 3, an exemplary far field RF based EDL system adapted for use with multiple EDLs is illustrated in block diagram format. RF based EDL system 200 can include numerous different EDLs 100, although only one is shown for purposes of simplicity in illustration. EDL system 200 can include an Application Software Server 210, which can be a special purpose computer that runs the specialized application software for system 200. Server 210 can contain a repository of access control information, codes and the like for all EDLs 100 in the facility. In various embodiments, only authorized operators are permitted to access or modify such information. For example, in the case of an office building, authorized operators might be building security and/or management, while users might be regular employees. As another example in the case of a hotel, authorized operators might be hotel management, operators able to assign newly coded EKeys 125 might be hotel staff, and users of EKeys might be hotel guests.

As will be readily appreciated, server 210 can include various components, such as a central processing unit (“CPU”) or other processor, random access memory (“RAM”), non-volatile memory, input and output devices, a data communications interface, and operating system (“OS”) and specialized application software, among other possible components. Server 210 can be hosted in any of a variety of ways, such as, for example, within an operator site, at an offsite hosted environment, or by way of a cloud server system, among other suitable possibilities.

Server 210 can be coupled to a computer network 220, which can provide data communication connectivity between the server and various other network items. Network 220 can be, for example, a local area network (“LAN”) for a given building or establishment. In some embodiments, network 220 can span multiple buildings or properties. Other implementations for network 220 can include a wide area network (“WAN”), TCP/IP, UDP, or tunneling protocol, among other suitable possibilities. A variety of network components and devices can be coupled to network 220, as will be readily appreciated. For example, various user stations or connections 201, 202 can provide access for operators or administrators to overall network 220 and system 200. Such stations can be, for example, a facilities administrator station 201 and a campus safety station 202, among other possibilities. Of course, many more stations may be coupled to any given network or system, as may be desired.

Each user station 201, 202 can include a number of components, such as a computer, processor, memory, network connection, monitor, input and output devices, and the like. A graphical user interface (“GUI”) on each user station or terminal can provide a convenient interface to an authorized user. Each user station or terminal can be provided in various ways including, but not limited to, a desktop computer, a laptop computer, a personal digital assistant, or a mobile computing platform such as a smart phone or tablet device. In some embodiments, a native GUI software platform may be used, and in some embodiments a web based browser may be provided.

In addition, one or more wireless routers 230 can be connected via network 220 to server 210. Wireless router(s) 230 can provide connectivity between the server and various wireless devices, such as EDL 100. Other wireless devices that may communicate with wireless router 230 can include EKeys 125, locators 240, 241, and other wireless routers, for example. Each wireless component can be battery powered or derive AC power locally, and wired components may receive power over Ethernet, among other power sources. Each wireless component may also have one or more antenna, which may be omnidirectional or may be specifically directed, as may be appropriate for the particular item. The range of each wireless component may vary, as may be appropriate for the item, building constraints and power conservation considerations. For example, some wireless routers 230 and locators 240, 241 may have an RF communications range of 200 feet or more.

The one or more EDLs 100 in system 200 may be adapted to detect and read wirelessly any EKey 125 that is within range of the EDL. A given EDL 100 will only unlock its respective door or lock if the detected EKey 125 is the correct one (i.e., contains an approved code or access permission). One or more EDLs can also be in communication with system server 210 for a variety of purposes. For example, server 210 can send a command message to EDL 100, upon which the EDL may respond back with a response message for a variety of purposes. For example, the addition or changing of a correct EKey code that will unlock the EDL might be one command and response communication, such as when hotel guests or business employees are added, changed, or deleted. Another communication type can involve alarm reports from EDL 100 to the system server 210. Such alarms can be in the event of unauthorized access through the lock, broken lock detection, low battery, or any asynchronous or irregular event, among other alarm possibilities.

One or more locators 240, 241 can be distributed about a building or other establishment as part of system 200. One type of locator 240 can be directly wired to the network 220 for power and/or communications purposes, while another type of locator 241 can be wireless and battery powered, for example. Such locators 240, 241 can generally be electronic devices that function like an EDL 100, only without any physical lock mechanism to lock, unlock or otherwise operate. These locators can be packaged a bit differently, and can be located in a wider variety of locations due to the absence of a physical lock requirement. Like EDL 100, locator 240, 241 can have one or more antenna, although different antenna configurations are possible. Typically highly directional antennas are used that are oriented differently along the azimuth to get azimuth estimate of the EKey's location. Such locators can similarly communicate with nearby EKeys 125, such as to detect and identify them and measure RSSI. The locators can then report such detected information to the system server 210, such that more data is available on the timing and presence of EKeys throughout the establishment. Such information can become useful in the event of a lost or missing person or stolen EKey, for example.

In addition to the foregoing components, one or more EKeys that are suitable for installation in a car (so-called In Car Units or “ICUs”) 250 can be present within system 200 and operable to communicate with one or more of the components therein. Such ICUs can be configured to activate suitably a gate, garage door, or other similar device that also uses an RF based EDL

As noted above, the reliability of a far field RF based EDL and EKey system that uses relatively large operating distances can benefit from the application of a plurality of antennas in the EDL. In various embodiments, at least one antenna can be at the inside room escutcheon part of the EDL, and at least one antenna can be at the outside room escutcheon part of the EDL (i.e., 123 and 133 in FIG. 2). More than one antenna can be used on each side for even greater accuracy in detecting and determining the presence, range and azimuthal location of a given EKey.

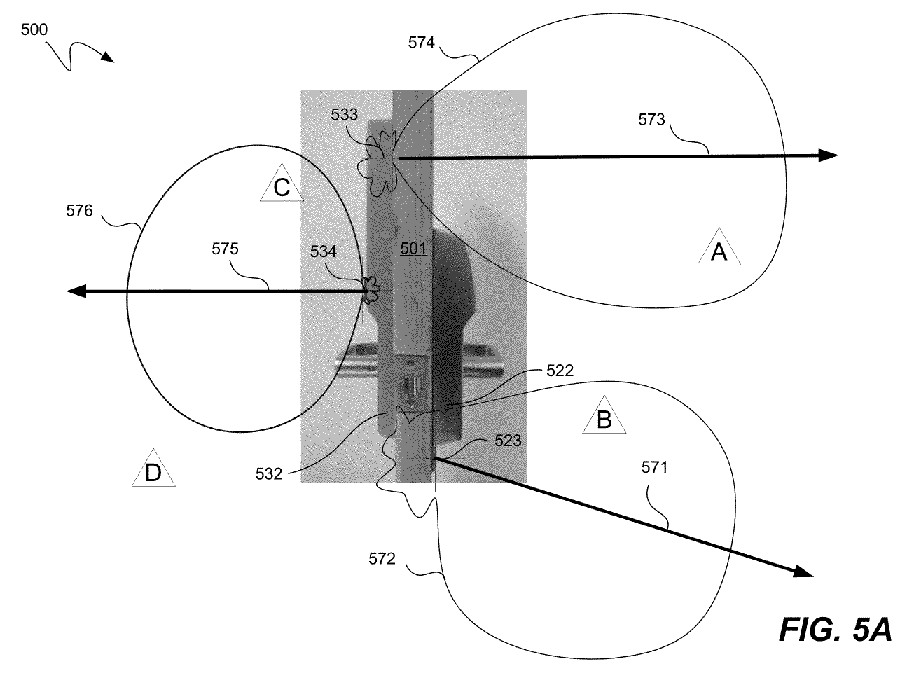

FIGS. 4A through 4E illustrate a typical radiation pattern along three axes (spatial and gain) for a given RF antenna arrangement in a far field RF based EDL according to one embodiment of the present invention. FIGS. 4A and 4B depict an RF based EDL in front elevation and side perspective views. EDL 400 can include an outside room escutcheon 422 and an inside room escutcheon 432, as well as a handle, antenna and other components. EDL 400 can be considered to have three orthogonal X, Y and Z axes, as shown. For an antenna that is situated within or about the front escutcheon, an outer region of a directed RF beam pattern along the Z axis rotation is shown as 461 in FIG. 4C (−3 dB beam-width of about ±47°), along the Y axis as 462 in FIG. 4D (−3 dB beam-width of about ±40°), and on the Z axis as 463 in FIG. 4E. It will be understood that the depicted X, Y and Z boundaries to the directed RF beam are shown on a logarithmic scale, such that the actual shape of the three-dimensional beam might resemble that of an elongated balloon extending outward from EDL 400.

In effect, the desired radiation pattern or beam is set up so that the EDL can detect that a correct EKey is in the designated space outside the door. The radiation pattern can be for the combined signal strength from both vertical and horizontal polarizations of more than one antenna. It will be understood that when a single antenna is mentioned, such an item may actually be one antenna assembly that has two antenna elements of orthogonal linear polarization in a common package with a switch. Thus a desired antenna element can be employed for a specific polarization at a given time. In various embodiments, the antenna can have very good front to back ratio, which can be easy to realize when the associated door is made of metal, but can be problematic with wooden doors. The actual beamwidth of the directed RF beam can be about 90 degrees or less in some embodiments.

Various problems with antenna directivity and beam formation arise due to the limited size of a typical EDL. For example, a typical EDL can have a width of only about 5-10 cm. Such issues can be addressed by designing a communication system that utilizes far field communications and has an operating frequency such that the resulting wavelength is appropriate for the relatively small sized EDL. For example, for a given EDL escutcheon having a frontal area of “A,” a width of “W,” and a height of “H,” a suitable operating frequency “F” can be the greater of the following three possibilities:

F≧0.5×300,000,000/sqrt(A); 1.

F≧0.5×300,000,000/W (i.e., W is at least half the free space wavelength); 2.

or

F≧0.5×300,000,000/H (i.e., H is at least half the free space wavelength). 3.

By using one of these formulae, this ensures that the EDL escutcheon body can be made largely of a metal conducting surface and be shaped such that an antenna placed on its air exposed side can operate while currents induced in the conducting surface do not get excited in a way that will result in coupling radiation in a direction opposite to the antenna.

Another problem can involve dealing with the spatial orientation of the EKey as it is carried or held by a user. Detecting and communicating with EKeys can be unpredictable due to such varying orientations, which can result in the appropriate communication link operating in two orthogonal linear polarizations. As such, both of the H and W dimensions should be large enough to provide a necessary metal base to radiate in the desired direction, yet prevent or suppress radiation in undesirable directions, such as, for example, back radiation. Accordingly, for an escutcheon having a frontal shape of a rectangle that is about 8 cm wide and 20 cm high, the operating frequency should be at least 1.875 GHz. (i.e., 1.5e8/0.08=1.875 GHz).

Despite the foregoing, when the escutcheon height is significant compared to the wavelength, the operating frequency can be chosen to be the lesser than three possibilities above and still be effective. In various embodiments, a three-dimensional Electro-magnetic Computer Aided Design (“3D EM CAD”) can be used to estimate how much lower the frequency can be, such that the escutcheon can still suppress back radiation so that the front to back gain ratio is at least 10 dB. With the foregoing setup, it is possible to realize an antenna having a main beam gain that is at least −9 dBi, while a typical gain would be about +3 dBi. For the foregoing exemplary parameters, an efficient high gain antenna with good beam definition can be realized. This can be realized in many ways, such as, but not limited to, the use of a single antenna element, or the use of an array of antenna elements. Beam coverage for the desired space can be realized, for example, by a fixed antenna beam, or by a steerable beam antenna, such as a phase array with 2 or more antenna elements. The antenna elements could be designed for operation in one frequency band or more than one frequency band, as will be readily appreciated by those of skill in the art.

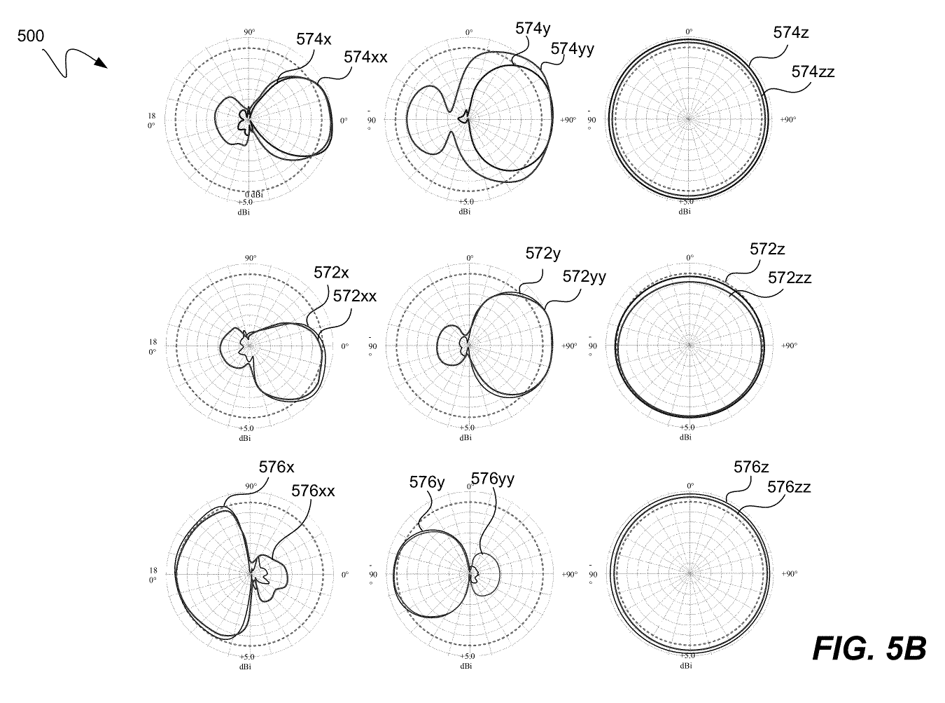

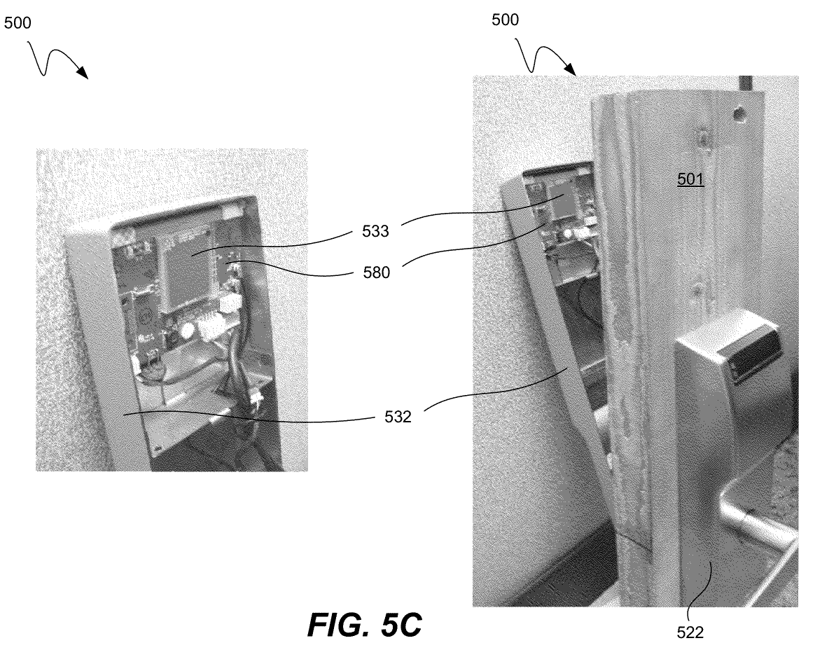

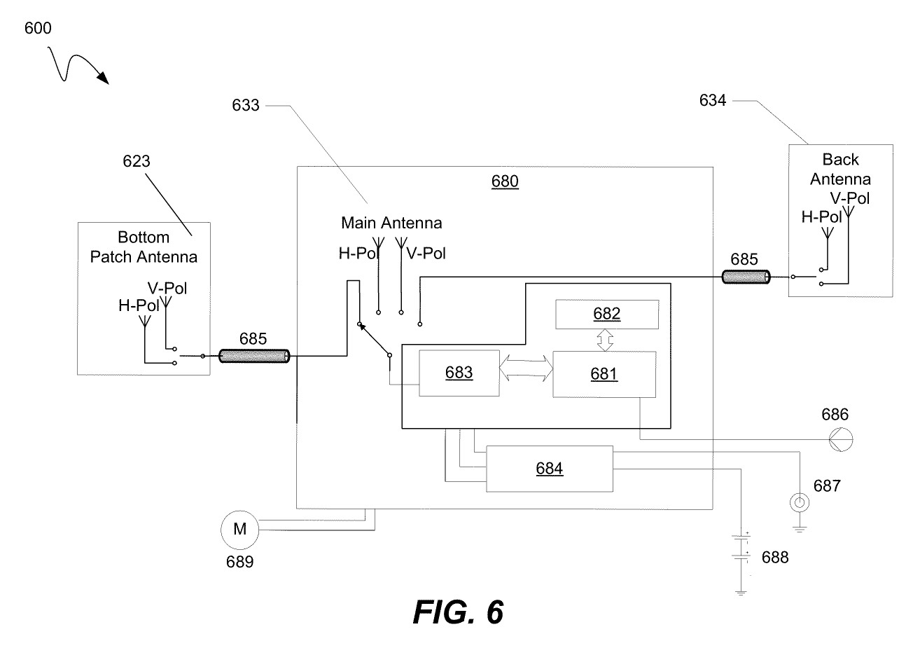

Moving now to FIG. 5A, an exemplary single far field RF based EDL having three directed beam antennas according to one embodiment of the present invention is illustrated in side elevation view. It will be readily appreciated that the configuration of far field RF based EDL 500 is merely exemplary in nature and does not limit the scope of the invention in any way. EDL 500 can be installed with respect to a wooden door 501, and have outside room escutcheon 522 and inside room escutcheon 532. One or more RF transceivers (not shown) can be located inside one or both of the escutcheons and operate at a frequency meeting the above criteria. The one or more transceivers can be switched to connect to one or more of the antennas 523, 533, 534. Where multiple antennas can be connected to a given transceiver, then a switchable connection to only one antenna at a time can be configured. Antennas 523, 533, 534 can all be directional antennas that form a beam, with antennas 523 and 533 having principle beam directions 571 and 573 respectively that are forward directed outside the door 501, and antenna 534 having a principle beam directions 575 that is backward directed inside the door.

Each of antennas 523, 533, 534 may have two radiating elements that can be switched to radiate in either horizontal or vertical polarizations. For the antennas of this arrangement, typical antenna gain can be about +5 dBi, while typical front to back ratio can be about 25 dB. Many types of antennas can be used to provide desired coverage, although a few antenna types have been found to be particularly attractive for EDL type applications for many reasons, such as, but not limited to, compactness, robustness, gain and efficiency. Such specific antenna types can include a patch antenna (half wave as well as quarter wave types), a slot antenna, and a cavity backed slot antenna (“CBSA”) As a particular non-limiting example, a CSBA built with a dielectric filled cavity (e.g. Rogers ceramic filled laminate, FR-4 laminate) has been found to be suitable.

As shown, antenna 533 illuminates the frontal side of the outside escutcheon 522. Antenna 533 is actually located at inside escutcheon 532 and radiates out through the wooden door 501 in radiation beam or pattern 574. Because antenna 533 might not provide sufficient coverage in a lower direction, which could be a problem when an EKey is carried in a pants pocket, for example, a second externally directed antenna 532 having a radiation beam or pattern 572 can be provided to give coverage in the lower direction. While both antennas 532 and 533 have back radiation extending into the interior part of the room space, such back radiation is at a much reduced intensity.

EDL 500 can provide protection against inadvertent unlocking of the door where a valid EKey is detected close to the interior side of the door at the EDL. For this feature, antenna 534 having a radiation beam or pattern 576 can be a broad beam that is directed into the interior space inside the door. An associated EDL processor can utilize as inputs the signals from the antennas 523, 533, 534 to determine the actual distance and location of an EKey with respect to the EDL to an accuracy of about 15 to 20%. This can be done by comparing the RSSI from antennas 523 and 533 with the RSSI of antenna 534. When communicating with an EKey located outside the door, the EDL will see a distinctly higher RSSI using antenna 523 and/or 533 as compared to the RSSI via antenna 534. Conversely, when communicating with an EKey located inside the door, the EDL will see a distinctly lower RSSI when using antenna 523 and/or 533 as compared to the RSSI via antenna 534.

As a particular exemplary process, a suitable associated microcomputer or other processor (not shown) in EDL 500 communicates with an EKey (not shown) using one or more transceivers (not shown) that are coupled to the 3 antennas, and receives RSSI from each antenna, correcting the RSSI for antenna gain and cable loss. Assuming for purposes of discussion that one transceiver is used, that all antennas have identical gains and cable losses, that the maximum RSSI from a front antenna is compared with the maximum RSSI from the back antenna, then a decision threshold of about 10 dB can provide a high confidence that the detected EKey is outside the door and not inside the door. A suitable formula for this concept could be represented as: (maximum front RSSI)−(maximum back RSSI)≧decision threshold. Of course, other configurations and potential processes may also be suitably used to arrive at suitable results as well. As specific examples, the locations A through D in FIG. 5A can result in the following:

| | RSSI (dB) | | | | | | | | |
|---|---|---|---|---|---|---|---|---|---|
| | using antenna | | | Maximum | Maximum | Front to Back | | | In reality is E- |
| E-key | Ant. | Ant. | Ant. | from front | from back | minimum RSSI | Decision | Evaluation | key exterior to |
| position | 533 | 523 | 534 | antenna | antenna | Difference | threshold | result | door? |
| A | −60 | −70 | −90 | −60 | −90 | 30 | 30 > 10 | TRUE | Yes |
| B | −55 | −61 | −85 | −55 | −85 | 30 | 30 > 10 | TRUE | Yes |
| C | −51 | −75 | −40 | −51 | −40 | −11 | −11 > 10 | FALSE | No |
| D | −80 | −71 | −57 | −71 | −57 | −14 | −14 > 10 | FALSE | No |

As set forth above, performing an RSSI comparison between EDL antenna beams that are pointed to the door space outside and inside can be a powerful technique that enables a reliable determination of an EKey location, whether the EKey is outside the door or inside the door. This approach also allows the use of directional antennas that do not have high front to back ratios. If an EKey has access permission to the door, and the EKey radiation pattern is near omni-directional, then line of sight RF propagation loss is a known function to distance and RSSI is a good estimator of distance where transmitter power and antenna gain are known. In such cases, the RF communication protocol can easily use the EKey and EDL transmitter powers and/or received RSSIs (corrected for respective antenna gain). Thus the associated EDL processor can determine when to unlock the door for an EKey that has valid access based on a set RSSI threshold (Maximum RSSI from front antennas) corresponding to a desired operating distance, where (Maximum RSSI from front antennas)−(Maximum RSSI from back antenna)≧Decision threshold.

This algorithm provides for unlocking an EDL when an authorized EKey is within a set operating distance from the EDL and the EKey is determined to be outside door, while also providing protection from incorrectly unlocking the door when the authorized EKey is within a set operating distance but is located inside the door. If the EDL contains antennas with two elements that radiate in orthogonal polarizations, then RSSI measurements can be performed on each polarization separately, as will be readily appreciated. Both measurements can then be combined by the EDL computer or processor. For example by summing the power to compute a value that is independent of the polarization of the EKey antenna, these values can be used in the above algorithm.

FIG. 5B depicts a set of antenna radiation patterns for the three antenna EDL 500 of FIG. 5A. The radiation patterns starting with 574, 572 and 576 correspond to the radiation patterns or beams 574, 572 and 576 respectively in FIG. 5A. The radiation patterns ending in single letters correspond to antennas with front to back ratios in excess of 30 dB, versus the radiation patterns ending in double letters that correspond to antennas with modest front to back ratios of about 25 dB. Further, the radiation patterns or beams ending in x and xx correspond to the x axis, y and yy correspond to the y axis, and z and zz correspond to the z axis. One can deduce from these patterns that differential RSSI discrimination results in the ready use of EDL with many types of antennas, which operate in spite of RF constraints posed by a variety of construction and door installations.

In fact, the EDL could use any of the antennas to communicate with other wireless devices, such as other EDLs or wireless routers through which connectivity to the application software server could exist. The EDL and/or server could periodically determine the most suitable antenna for such communication by measuring the received signal strength or the quality of signals from another wireless device on multiple alternative antennas. Also, the EDL could have additional antennas with beam pattern that allow more fine grained tracking of the movement of an EKey with respect to a given EDL. For example, an antenna with a beam that is directed to the side of the EDL could be used to discern whether an EKey is entering or leaving a room when the door is at an open or ajar state.

FIG. 5C depicts the RF based EDL having three directed beam antennas from FIG. 5A according to one embodiment of the present invention in two different partially disassembled views. Again, EDL 500 can be installed on a wood door 501, and can include an outside escutcheon 522, an inside escutcheon 532, and a patch type antenna 533, among other components. In addition, an EDL printed circuit board (“PCB”) can include a transceiver, processor, memory, power regulator, and other pertinent processing components to facilitate the overall operation of EDL 500.

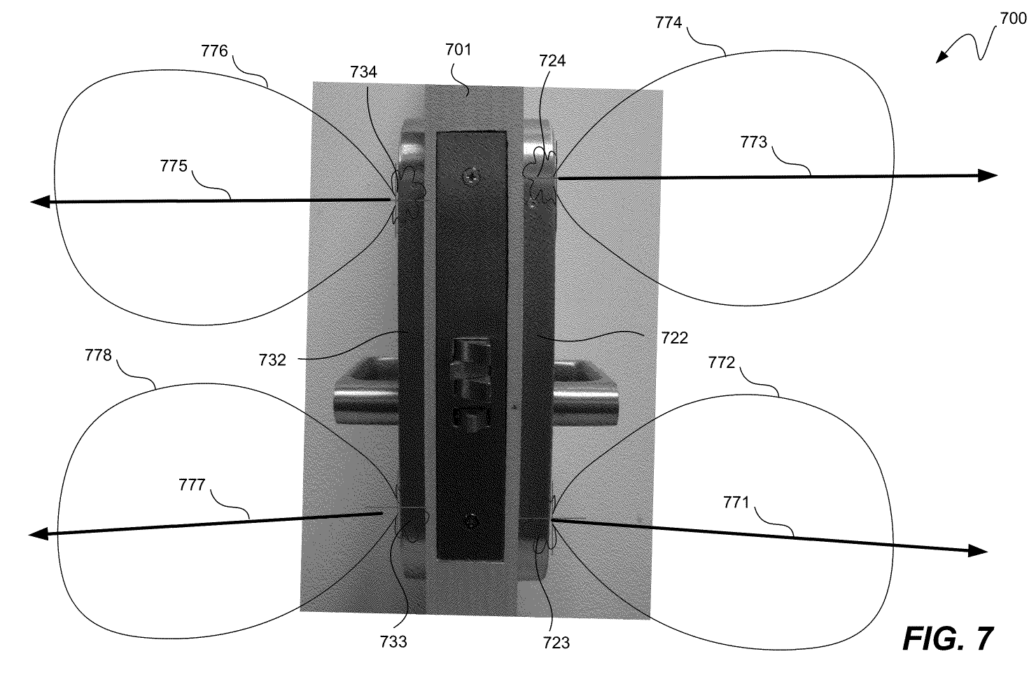

Turning next to FIG. 6, a block diagram of various components of an exemplary RF based EDL such as that of FIG. 5A is provided. EDL 600 can include a PCB 680 with a microcomputer 681 having a central processing unit (“CPU”), random access memory (“RAM”), non-volatile memory, and one or more Input-Output ports, among other possible components. The PCB can also include power management functions or items 684, and an optional external memory 682 to store information that cannot be accommodated on the chip memory of microcomputer 681. The information in external memory 682 may additionally be encrypted to prevent unauthorized persons from reading the information, while the microcomputer 681 can read or write the external memory properly.

A radio transceiver 683 can also be included, as well as antennas 623, 633, 634 having directed main beams pointing in various directions. These antennas may consist of multiple radiating elements that radiate in different polarizations, as noted above. Various coaxial cable 685 coupled RF switches can be controlled by the microcomputer to connect the transceiver 683 to a specific antenna. In various embodiments, the CPU can execute an operating program read from either RAM or non-volatile memory to implement the desired functionality. Additional components can include a dead latch position sensor 686, a DC power jack 687, a DC power source 688 and an electromechanical actuator 689. Further components may also be included as may be desired.

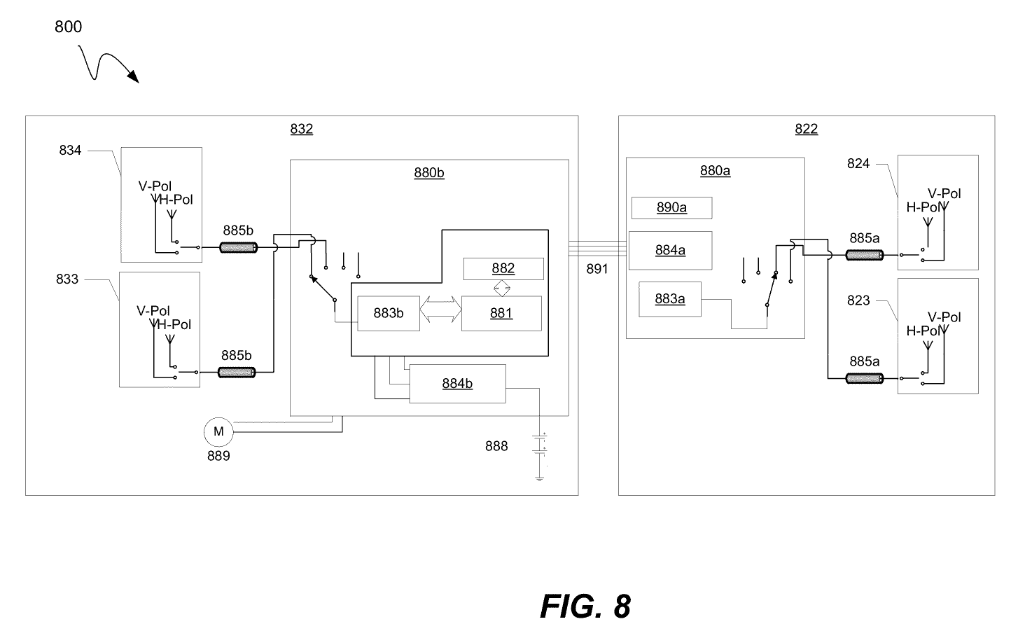

Moving next to FIG. 7, an exemplary alternative single far field RF based EDL having four directed beam antennas is shown in side elevation view. EDL 700 is similar to previously described EDL 500, except that there are two internally pointing antennas rather than just one. Communication coverage for the interior space is covered by two antennas 733, 734, which have principle beam directions 777, 775 and radiation patterns 778, 776 respectively. Communication coverage for the exterior side of door 701 is covered by two antennas 723, 724, which have principle beam directions 771, 773 and radiation patterns 772, 774 respectively. All antennas 723, 724, 733, 734 can couple EM waves directly into the space outside, and thus can be used in situations where the door is made of wood (i.e., RF transparent) or with an RF opaque door, such as a fire rated door made of steel. While the battery and PCB with computer, transceiver and the like can be housed in the interior escutcheon 732, one could optionally place a separate transceiver in the external escutcheon 722 to connect to the two antennas available there.

Advantages of this particular topology include that this topology avoids RF cable wires routing between outside and inside escutcheons, which are prone to cost and installation constraints. This layout also improves the isolation between the pairs of antennas that are connected to different transceivers. Further, this topology also allows EDL 700 to monitor its ambient RF reflection environment by measuring RF isolation between outside antennas and interior antennas. Changes in RF environment may be configured to change operating mode of the EDL 700 or generate event report to the application software server.

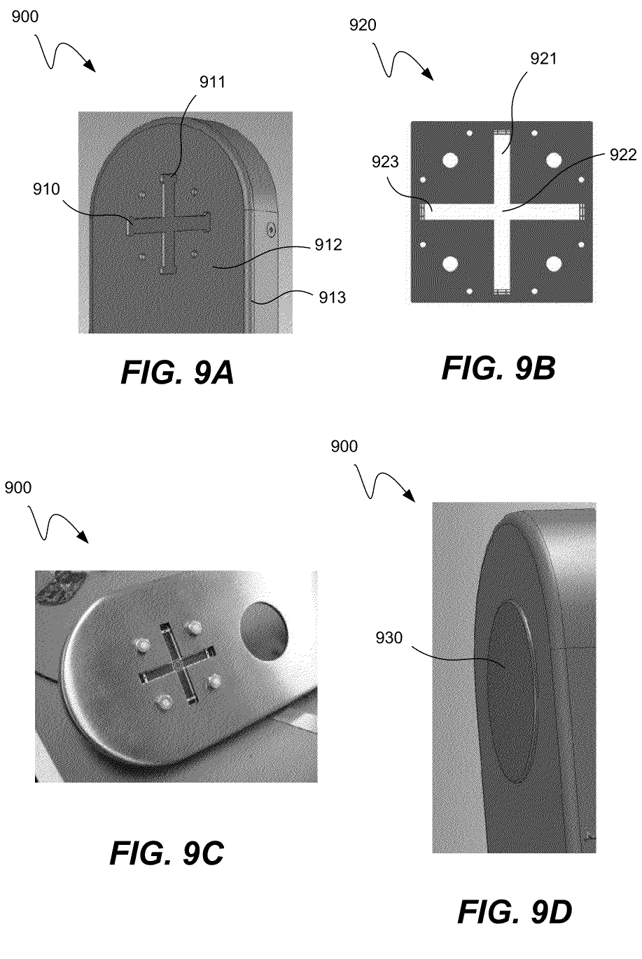

FIG. 8 illustrates in block diagram format various components of an overall circuit for another exemplary RF based EDL, such as that of FIG. 7. The layout and components for EDL 800 can be somewhat similar to those for EDL 600 above, for example. Differences include a second circuit in the outside escutcheon 822 with a second radio transceiver 883a. The second radio transceiver 883a can be connected to the outside antennas 823, 824 via an RF switch, while the first transceiver 883b is connected to the inside antennas 833, 834 via an RF switch. The circuit in the outside escutcheon 822 is controlled by the microcomputer via a cable 891. EDL 800 can include a PCB 880a for outside escutcheon 822, and also a separate PCB 880b for inside escutcheon 832. A microcomputer 881 can be on one or both PCBs, with the microcomputer similarly having a CPU, RAM, non-volatile memory, and one or more Input-Output ports, among other possible components. One or both PCBs 880a, 880b can also include power management functions or items 884a, 884b, and an optional external memory 882 to store information that cannot be accommodated on the chip memory of microcomputer 881. The information in external memory 882 may additionally be encrypted to prevent unauthorized persons from reading the information, while the microcomputer 881 can read or write the external memory properly.

A radio transceiver 883a, 883b can also be included on one or both PCBs, as well as antennas 823, 824, 833, 834 having directed main beams pointing in various directions. Again, these antennas may consist of multiple radiating elements that radiate in different polarizations, as noted above. Various coaxial cable 885a, 885b coupled RF switches can be controlled by the microcomputer to connect the transceiver 883a, 883b to a specific antenna. In various embodiments, the CPU can execute an operating program read from either RAM or non-volatile memory to implement the desired functionality. Additional components can similarly include DC power 888 and an electromechanical actuator 889, among others.

In various embodiments, a metallic door handle located close to the antennas could in some cases distort the beam shape. This could constrain the ability to reduce the size of the escutcheon. As such, handles constructed of a material that does not interfere with RF beam formation can be advantageous. Thus, a handle made of plastic composite material provides necessary mechanical strength as well as optimal features for a good RF performance. One interesting antenna design that fits the mechanical robustness, finish and RF requirements can involve the use of the escutcheon metal surface as an integral part of the antenna itself.

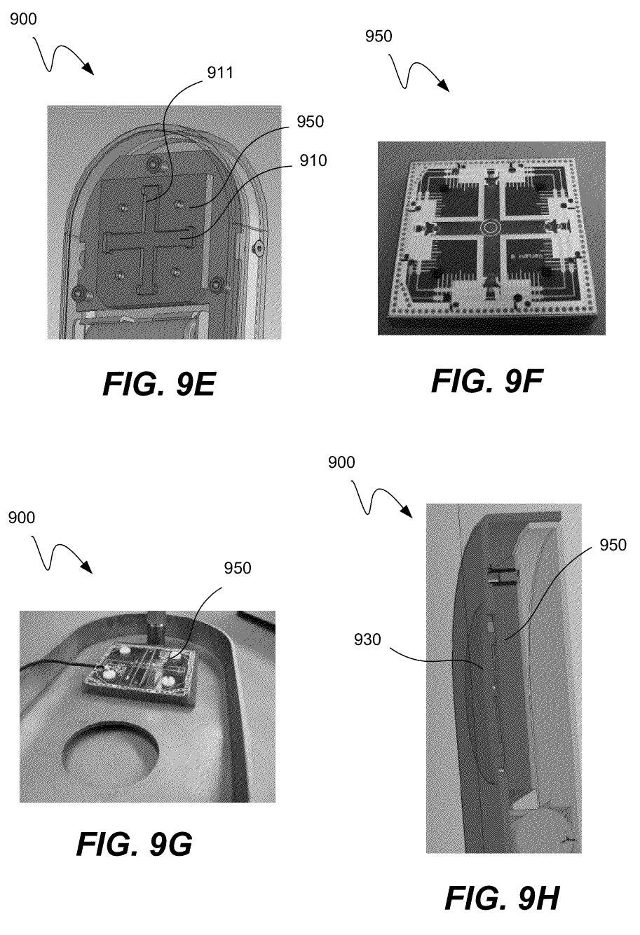

Referring lastly to FIGS. 9A through 9H, various views and embodiments of exemplary escutcheons, escutcheon slots, cross slot arrangements, cavity backed slot antennas and slot covering radomes are provided. In particular two slot antennas can be used in combination, such as that which is shown in escutcheon 900. This can be accomplished by cutting or otherwise forming two crossing slots 910, 911 in the metal escutcheon. The slots can be aligned and mated to a CBSA 950 situated behind the slots, which CBSA can be is made of a high dielectric constant material. An escutcheon slot can couple the slot 923 of the CBSA to space. The slot antenna thus induces current on the escutcheon flat surface 912 around the slot like a conventional slot antenna, making the escutcheon a radiative element of the antenna. This results in a far field EM radiation pattern, albeit on the outside portion of the slot, while the inside portion of slot is mated and contained by the CBSA. The RF radiation is thus accomplished by the escutcheon metal, which acts as an antenna. The escutcheon slot or slots can then be covered with a non-metallic filler 930, such as an ABS plastic fillet radome. Radome 930 not only fills the escutcheon slot, but could be stylized in various ways as may be desired. The radome 930 can server to prevent a vandal or thief from reaching the slot easily. The slot itself does not compromise mechanical strength and toughness of the escutcheon, since it is relatively small and narrow.

In particular, by having two slot antennas with horizontal and vertical polarizations, a reasonably accurate RF beam can be formed to a significant range of about 6 feet or more using only the limited space that is available within an ordinary EDL. Again, use of a CBSA can also be effective in these arrangements.

The CBSA slot or slots can be further augmented to provide for a light pipe 921 to allow the subject EDL to give optical user feedback, and or to provide an inductive coil 922 at the center of the slot where RF current flow is minimal to allow power coupling to the EDL, in the event that the battery is expended. Also, the escutcheon surface can be used as part of a slot antenna. In this manner, escutcheon surface areas can carry a significant amount of RF current to be processed (e.g. mechanical stress relieved) to ensure an efficient current flow. 3D EM CAD tools can identify parasitic loss element (e.g., lossy magnetic permeability) or unwanted surface current flow to better control antenna loss, as well as to suppress modes that negatively affect beam formation and in particular front to back ratio. The surface can be prepared to increase RF loss in certain areas (e.g. by inducing or not relieving cold work induced stresses).

In various further embodiments and details, an EDL can be used as a locator that communicates with one or more EKeys to determine EKey location as the keys are near or pass by the EDL. Reporting back to the server can be made in such events, such that keys can be tracked as they move about the establishment. Actual pinpoint distance and location of a given key with respect to an EDL can be had to an accuracy having an error range of about 15 to 20% when multiple antenna beams are used. Other uses can include EDLs on, for example, wall readers, electronic safes, cabinet doors, filing cabinets, drug cabinets, bank lockers, mail boxes, safety deposit boxes and the like.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. An electronic door lock adapted to interact with an electronic key unit having a key antenna and a transmitter configured to transmit a radio frequency (“RF”) signal over the key antenna, the RF signal containing an identification (“ID”) code identifying the electronic key unit, the electronic door lock comprising:
a first antenna adapted to form a first directional radiation beam to receive the RF signal from the key unit;
a second antenna adapted to form a second directional radiation beam to receive the RF signal from the key unit; and
a processing component adapted to use RF signals received by one or both of the first and second antenna to determine whether the presence of an acceptable ID code is detected on the key.

2. The electronic door lock of claim 1, wherein the processing component is adapted to determine the distance and spatial location of the key unit with respect to the electronic door lock.

3. The electronic door lock of claim 1, wherein the first directional radiation beam points to the inside of the door and the second directional radiation beam points to the outside of the door.

4. The electronic door lock of claim 1, further including:
a third antenna adapted to form a third directional radiation beam to receive the RF signal from the key unit.

5. The electronic door lock of claim 4, wherein the first and second directional radiation beams point toward the outside of the door, and wherein the third directional radiation beam points toward the inside of the door.

6. The electronic door lock of claim 1, wherein at least one of said first and second antennas form a cavity backed slot antenna.

7. The electronic door lock of claim 1, further including:
a metal escutcheon housing at least one or more of the antennas.

8. The electronic door lock of claim 7, wherein the metal escutcheon housing has two crossing slots formed therein to provide vertical and horizontal polarizations for two slot antennas.

9. The electronic door lock of claim 8, further including:
an exterior radome configured to cover the two crossing slots.

10. The electronic door lock of claim 8, wherein a single cavity is used to realize both horizontal and vertical polarization antennas.

11. The electronic door lock of claim 7, wherein at least one of the first and second antennas operate such that for the escutcheon having a frontal area A, a width W and a height H, its operating frequency F is the greater of the following possible equation results:
F=0.5×3e8/sqrt(A)
F=0.5×3e8/W
or
F=0.5×3e8/H

12. The electronic door lock of claim 7, wherein the escutcheon includes an aperture that is used for an antenna to perform RF communication with EKeys.

13. The electronic door lock of claim 12, wherein the aperature is also used for an indicator light, a non-contact backup power transfer, or a capacitive touch sensor for user input or interaction.

14. The electronic door lock of claim 7, wherein at least a portion of the metal escutcheon surface is used as part of one of said antennas.

15. The electronic door lock of claim 1, wherein at least one of said first and second antennas is selected from the group consisting of a patch antenna, a slot antenna, a cavity backed slot antenna, a dipole antenna, a folded dipole antenna, an inverted F antenna, and an L antenna.

16. The electronic door lock of claim 1, wherein the operating frequency of said first antenna is at least 2 GHz.

17. The electronic door lock of claim 1, wherein each antenna consists of two radiating elements in close proximity that radiates in two different linear polarizations with respect to each other.

18. The electronic door lock of claim 1, wherein said first antenna is located on an escutcheon inside of the room and provides coverage through an associated RF transparent door to the door exterior.

19. The electronic door lock of claim 1, wherein the multiple directional radiation beams make it possible to discern whether an associated EKey is entering or leaving a room associated with the electronic door lock while an associated door is at an open or ajar state.

20. An electronic door lock system, comprising:
a plurality of electronic door locks adapted to interact with an electronic key unit having a key antenna and a transmitter configured to transmit a radio frequency (“RF”) signal over the key antenna, the RF signal containing an identification (“ID”) code identifying the electronic key unit, wherein each of the plurality of electronic door locks includes a first antenna adapted to form a first directional radiation beam to receive the RF signal from the key unit, a second antenna adapted to form a second directional radiation beam to receive the RF signal from the key unit, a processing component adapted to use RF signals received by one or both of the first and second antenna to determine whether the presence of an acceptable ID code is detected on the key; and
a server in communication with the plurality of electronic door locks, said server being adapted to update information on each of the plurality of electronic door locks regarding ID codes for new or reissued electronic key units.
